(19) United States
(12) Patent Application Publication
(10) Pub. No.: US 2015/0112012 A1
(43) Pub. Date: Apr. 23, 2015

(54) HOT MELT ADHESIVE

(71) Applicant: HENKEL AG & CO. KGAA, Duesseldorf (DE)

(72) Inventor: Ai Takamori, Osaka (JP)

(21) Appl. No.: 14/583,916

(22) Filed: Dec. 29, 2014

Related U.S. Application Data
(63) Continuation of application No. PCT/JP2013/068313, filed on Jun. 27, 2013.

(30) Foreign Application Priority Data
Jun. 28, 2012 (JP) 2012-144972

(51) Int. Cl. C09J 167/02; C09J 123/20

(52) U.S. Cl. CPC C09J 167/02; C09J 123/20
USPC 524/513

(57) ABSTRACT

Disclosed is a hot melt adhesive comprising: (A) a copolymer of ethylene/olefin having 3-20 carbons; and (B) a polyester polyol. The hot melt adhesive can be applied at low temperature and has a suitably long open time. Particularly, the hot melt adhesive is excellent in adhesion to a paper and is useful as a hot melt adhesive for papers.

### CROSS-REFERENCE TO RELATED APPLICATIONS

This application is a continuation of International Patent Application No. PCT/JP2013/068313 filed Jun. 27, 2013, which claims priority to Japanese Patent Application No. 2012-144972 filed on Jun. 28, 2012 in Japan, the contents of both of which are incorporated herein by reference.

### FIELD OF INVENTION

The present invention relates to a hot melt adhesive. Furthermore, the present invention relates to a paper product obtainable using the hot melt adhesive.

### BACKGROUND OF THE INVENTION

A hot melt adhesive is a solvent-free adhesive and has features enabling of instant bonding and high-speed bonding since adhesion of the adhesive is exhibited after the adhesive is heated, melted, applied to an adherend and then solidified by being cooled. For example, the hot melt adhesive is now widely used in paper processing, woodworking, sanitary material and electronic fields.

There have been used commonly, as a base polymer of the hot melt adhesive, ethylene-based copolymers such as an ethylene-vinyl acetate copolymer (hereinafter also referred to as “EVA”) and an ethylene-ethyl acrylate copolymer (hereinafter also referred to as “EEA”); olefin-based resins such as polyethylene, polypropylene and amorphous polyalphaolefin (hereinafter also referred to as “APAO”); synthetic rubbers such as a styrene-based block copolymer (for example, a styrene-isoprene-styrene-based block copolymer (hereinafter also referred to as “SIS”), a styrene-butadiene-styrene-based block copolymer (hereinafter also referred to as “SBS”) and a hydrogenated product thereof; polyurethanes; and the like, according to the intended use.

Among these hot melt adhesives, a hot melt adhesive containing the ethylene-based copolymer as a base polymer is frequently used in the paper processing field such as bookbinding and packing, film processing, and the woodworking field.

When the ethylene-based hot melt adhesive is applied to an adherend such as a paper or a film, a special coating applicator called a hot melt applicator is frequently used. The hot melt applicator includes a nozzle which is a dispense port, and the hot melt adhesive is heated to about 120 to 190° C., dispensed from a nozzle tip and applied to an adherend.

Japanese Publication Nos. 7-150123, 2008-527067, and 2008-214539 disclose hot melt adhesives containing an ethylene-based copolymer as a base polymer.

Japanese Publication No. 7-150123 discloses a hot melt adhesives containing an ethylene/ethyl acrylate as one component (see claim 1 and Table 1 of Japanese Publication No. 7-150123). The same document discloses that a hot melt adhesive having excellent adhesion to a polyolefin-based resin is obtainable by mixing an ethylene/ethyl acrylate, a specific polyester, and a compatibilizing agent (see [0006], [0038] of Japanese Publication No. 7-150123).

Japanese Publication Nos. 2008-527067 and 2008-214539 disclose hot melt adhesives containing two components of an ethylene/olefin copolymer and an ethylene/carboxylic acid ester copolymer (see claim 1 and Table 1 of Japanese Publication No. 2008-527067, Table 1 of Japanese Publication No. JP 2008-214539). Both documents disclose an effect that stringing (or stringing property) of the hot melt adhesive is reduced (or the adhesive is excellent in stringing resistance), the stringing being generated when the adhesive is applied to an adherend (see Table 1 and [0038] of Japanese Publication No. 2008-527067, Table 1 and [0025] to [0027] of Japanese Publication No. 2008-214539).

Recently, various performances, particularly low temperature coatability, have been required to an ethylene-based hot melt adhesive. Application of a hot melt adhesive to an adherend (or base material) at high temperature is not preferable since it may sometimes exert an adverse influence on a coating line according to the type of the adherend and/or the composition of the adhesive. Therefore, progress has been made in the development of a hot melt adhesive which can be applied to an adherend at low temperature of about 120 to about 140° C.

The hot melt adhesive of Japanese Publication No. 7-150123 is heated to 150° C. and then bonded to an adherend (see [0024] of Japanese Publication No 7-150123). The hot melt adhesive of Japanese Publication No. 2008-527067 is ejected through a nozzle at 170° C. or 180° C. (see [0037] of Japanese Publication No. 2008-527067), and the hot melt adhesive of Japanese Publication No. 2008-214539 is ejected through a nozzle at 180° C. (see [0021] of Japanese Publication No. 2008-214539). Each of the hot melt adhesives of Japanese Publication Nos. 7-150123, 2008-527067, and 2008-214539 is excellent in thermal stability since they are applied at high temperature, but is not suited for low temperature (120 to 140° C.) coating.

Taking wettability to the adherend and coatability to an adherend having a complicated shape into consideration, it is required for the hot melt adhesive to have a suitably long open time. When the open time of the hot melt adhesive is too short, it becomes difficult to bond.

Paper manufacturers or film manufactures desire a hot melt adhesive having a certain degree of adhesion even though the adhesive is applied in a small amount.

Particularly in the paper processing field, a carton for wrapping products is downsized. Therefore, when a large amount of an adhesive is applied, the adhesive may sometimes protrude in processing (namely, an area coatable with an adhesive becomes narrow). Therefore, there is an urgent need to develop a hot melt adhesive which has a certain degree of adhesion to a paper even though the adhesive is applied in a small amount, and also has satisfactory adhesion in a wide temperature range.

### SUMMARY OF THE INVENTION

An object of the present invention is to provide a hot melt adhesive which can be applied at low temperature and has a suitably long open time, and is particularly excellent in adhesion to a paper. Another object thereof is to provide a paper product produced by using the hot melt adhesive.

The present inventors have intensively studied and found that the above-mentioned object can be achieved by mixing a specific polyester, that is, polyester polyol with a specific ethylene-based copolymer, and thus the present invention has been completed.

Namely, in an aspect, the present invention provides a hot melt adhesive comprising: (A) a copolymer of ethylene/olefin having 3-20 carbons; and (B) a polyester polyol.

In a preferred embodiment, the present invention provides the hot melt adhesive, wherein the copolymer of ethylene/olefin having 3-20 carbons (A) includes a copolymer of ethylene with octene.

In another embodiment, the present invention provides the hot melt adhesive, wherein the polyester polyol (B) has a glass transition temperature of 30° C. or lower.

In a most preferred embodiment, the present invention provides the hot melt adhesive, wherein the polyester polyol (B) has at least one chemical structure selected from chemical structures derived from phthalic acids and chemical structures derived from adipic acids.

In another aspect, the present invention provides a paper product produced by using the above hot melt adhesive.

### DETAILED DESCRIPTION OF THE INVENTION

Since the hot melt adhesive according to the present invention includes (A) a copolymer of ethylene/olefin having 3-20 carbons, and (B) a polyester polyol, the hot melt adhesive can be applied at low temperature, and also has a suitably long open time. The hot melt adhesive is particularly excellent in adhesion to a paper and is useful as a hot melt adhesive for papers. Recently, a small wrapping carton which is not coatable with a large amount of an adhesive (namely, an area coatable with an adhesive is narrow) has been circulated. The hot melt adhesive according to the present invention also exhibits excellent adhesion to the special carton and can maintain the adhesion in a wide temperature range.

When the copolymer of ethylene/olefin having 3-20 carbons (A) includes a copolymer of ethylene with octene, the hot melt adhesive according to the present invention is further excellent in adhesion to the carton even though a small amount of the adhesive is applied, and can maintain more excellent adhesion even in a low temperature range of −20° C. to 0° C.

When the polyester polyol (B) has a glass transition point of 30° C. or lower, the hot melt adhesive according to the present invention is more excellent in adhesion in a wide temperature range.

When the polyester polyol (B) has at least one chemical structure selected from chemical structures derived from phthalic acids and chemical structures derived from adipic acids, the hot melt adhesive according to the present invention is more excellent in adhesion to a carton even though a small amount of the adhesive is applied, and can maintain more excellent adhesion even in particularly low temperature range of −20° C. to 0° C.

Since the paper product according to the present invention is producible by using the above-mentioned hot melt adhesive, it is possible to produce in a low temperature coating line. Therefore, an adverse influence is not exerted on a coating line and an adherend (or a base material), particularly a paper of the hot melt adhesive. Furthermore, since the hot melt adhesive has a suitably long open time, it is possible to provide some margin for a step of producing a paper product by bonding. Because of small application amount of the hot melt adhesive, the adhesive does not protrude in processing the paper product.

As used herein, the “open time” means a time until it is impossible for a hot melt adhesive to wet a surface of an adherend because of disappearance of fluidity of the adhesive after application of the adhesive to an adherend.

The hot melt adhesive according to the present invention comprises: (A) a copolymer of ethylene/olefin having 3-20 carbons, and (B) a polyester polyol.

As used herein, the “hot melt adhesive” means an adhesive which is solid at normal temperature and has fluidity by being heated and melted and, for example, an adhesive which can be applied to a target such as a base material or an adherend, and also can be solidified and bonded by being cooled.

In the present invention, the “(A) copolymer of ethylene/olefin having 3-20 carbons” (hereinafter referred to as a “(A) copolymer”) means a copolymer of ethylene with olefin having 3-20 carbons, and is not particularly limited as long as the objective hot melt adhesive according to the present invention is obtainable.

Specific examples of the “olefin having 3-20 carbons” include propylene, 1-butene, 1-pentene, 1-hexene, 1-heptene, 1-octene, 1-nonene, 1-decene, cis-2-butene, trans-2-butene, isobutylene, cis-2-pentene, trans-2-pentene, 3-methyl-1-butene, 2-methyl-2-butene, 2,3-dimethyl-2-butene and the like. An olefin having 3-10 carbons is preferable, propylene, butene and octene are more preferable, and octene is particularly preferable.

Examples of the copolymer (A) include (i) a copolymer of ethylene with octene, (ii) a copolymer of ethylene with propylene and 1-butene, (iii) a copolymer of ethylene with propylene, (iv) a copolymer of ethylene with butene and the like.

In the present invention, it is particularly preferable that the copolymer (A) includes (i) the copolymer of ethylene with octene. It is possible to use commercially available products as the copolymer (A).

Examples of the copolymer of ethylene with octene (i) include AFFINITY GA1900 (trade name), AFFINITY GA1950 (trade name), AFFINITY EG8185 (trade name), AFFINITY EG8200 (trade name), ENGAGE 8137 (trade name), ENGAGE 8180 (trade name), ENGAGE 8400 (trade name) and the like, manufactured by The Dow Chemical Company.

Examples of the copolymer of ethylene with propylene and 1-butene (ii) include VESTOPLAST 703 (trade name), VESTOPLAST 708 (trade name) and the like, manufactured by EVONIK DEGUSSA.

Examples of the copolymer of ethylene with propylene (iii) include Eastoflex E1016PL-1 and the like, manufactured by Eastman Chemical Company.

Examples of the copolymer of ethylene with butene (iv) include TAFMER A4085 and the like, manufactured by Mitsui Chemicals Inc.

These copolymers of ethylene with olefin having 3-20 carbons can be used alone or in combination.

The copolymer (A) preferably has a melt flow rate of 10 to 2,000 g/10 minutes, more preferably 10 to 1,500 g/10 minutes, and most preferably 300 to 1,200 g/10 minutes.

When the melt flow rate is within the above range, a hot melt adhesive having more excellent balance among adhesive force, heat resistance, and low temperature coatability is obtained.

As used herein, the “melt flow rate” means an index which indicates fluidity of a resin and is determined by heating and pressurizing a given amount of a synthetic resin at a predetermined temperature (190° C.) in a cylindrical vessel heated by a heater, and measuring the amount of the resin extruded through an orifice (nozzle) provided on the bottom of the vessel per 10 minutes. Unit of g/10 minutes is used. An extrusion-type plastometer defined in JIS K6769 is used as a testing machine, and the measurement is performed by the measurement method defined in JIS K7210.

In the present invention, examples of the copolymer (A) having a melt flow rate within the above range include copolymers of ethylene with octane, such as AFFINITY GA1900 (trade name), AFFINITY GA1950 (trade name), and AFFINITY EG8185 (trade name) manufactured by The Dow Chemical Company; and ENGAGE 8137 (trade name) and ENGAGE 8400 (trade name) manufactured by The Dow Chemical Company.

The hot melt adhesive according to the present invention may contain the other ethylene-based copolymer as long as it contains the copolymer (A).

The “other ethylene-based copolymer” means a copolymer of ethylene with the other polymerizable monomer other than the “olefin having 3-20 carbons”. The “other polymerizable monomer” is a monomer other than the “olefin having 3-20 carbons”, having an ethylenic double bond which is radically polymerizable with ethylene, and it is not particularly limited as long as the “other ethylene-based copolymer” is capable of giving the hot melt adhesive according to the present invention.

Specific examples of the “other polymerizable monomer” include carboxylic acid ester, carboxylic anhydride, carboxylic acid and the like.

The other ethylene-based copolymer is a copolymer of ethylene with the “other polymerizable monomer”, and preferably has a weight average molecular weight of 10,000 or more, and more preferably 15,000 or more. Also, the copolymer (A) preferably has a weight average molecular weight of 10,000 or more, and more preferably 15,000 or more.

The weight average molecular weight means a value obtained by gel permeation chromatography (GPC) in terms of polystyrene standards. Specifically, a weight average molecular weight can be measured by the following GPC apparatus and measurement method. HCL-8220GPC manufactured by TOSOH CORPORATION is used as the GPC apparatus, and RI is used as the detector. Two TSKgeI SuperMultipore HZ-M manufactured by TOSOH CORPORATION are used as a GPC column. A sample is dissolved in tetrahydrofuran, and the solution is allowed to flow at a flow rate of 0.35 ml/min and a column temperature of 40° C. to obtain a measured value of a molecular weight. By a calibration curve using polystyrene having a monodispersed molecular weight as a standard substance, the measured molecular weight is converted to obtain the objective weight average molecular weight.

The “ethylene/carboxylic acid ester copolymer” means a copolymer of ethylene with a carboxylic acid ester having an ethylenic double bond.

Examples of the carboxylic acid ester having an ethylenic double bond include (meth)acrylic acid esters such as methyl(meth)acrylate, ethyl(meth)acrylate, butyl(meth)acrylate, and 2-ethylhexyl(meth)acrylate; carboxylic acid vinyl esters such as vinyl acetate and allyl acetate; allyl ester and the like.

As used herein, the (meth)acrylic acid ester means both an acrylic acid ester and a methacrylic acid ester.

Examples of the “ethylene/carboxylic acid ester copolymer” include a copolymer of ethylene with a (meth)acrylic acid ester, a copolymer of ethylene with vinyl carboxylate, and a copolymer of ethylene with allyl carboxylate, and the copolymer of ethylene with a (meth)acrylic acid ester and the copolymer of ethylene with vinyl carboxylate are particularly preferable.

Examples of the copolymer of ethylene with a (meth)acrylic acid ester include a copolymer of ethylene with methyl methacrylate, a copolymer of ethylene with ethyl acrylate, a copolymer of ethylene with butyl acrylate, a copolymer of ethylene with butyl methacrylate and the like.

Examples of the copolymer of ethylene with vinyl carboxylate include a copolymer of ethylene with vinyl acetate.

The “ethylene/carboxylic acid copolymer” means a copolymer of ethylene with carboxylic acid having an ethylenic double bond.

The carboxylic acid having an ethylenic double bond is a compound having an ethylenic double bond and a carboxyl group, and there is no particular limitation as long as the hot melt adhesive according to the present invention can be obtained. Specific examples thereof include oleic acid, linoleic acid, maleic acid, itaconic acid, succinic acid, acrylic acid, and methacrylic acid.

Specific examples of the ethylene/carboxylic acid copolymer include a copolymer of ethylene with acrylic acid, and a copolymer of ethylene with methacrylic acid.

The “ethylene/carboxylic anhydride copolymer” means a copolymer of ethylene with carboxylic anhydride having an ethylenic double bond.

The carboxylic anhydride having an ethylenic double bond is a compound having a carboxylic anhydride group in which two carboxyl groups undergo dehydration condensation, and there is no particular limitation as long as the hot melt adhesive according to the present invention can be obtained. Specific examples thereof include maleic anhydride and the like.

Specific examples of the ethylene/carboxylic anhydride copolymer include a copolymer of ethylene with maleic anhydride.

In the present invention, the polyester polyol (B) is a “main chain type” polyester and is a compound having an ester bond and a hydroxyl group in the “main chain”, and there is no particular limitation as long as the objective hot melt adhesive according to the present invention can be obtained.

A glass transition point of the polyester polyol (B) is preferably 30° C. or lower, more preferably from −70° C. to 30° C., and most preferably from −60° C. to 25° C. When the polyester polyol (B) has the glass transition point within the above range, the hot melt adhesive according to the present invention is more excellent in adhesion in a wide temperature range.

As used herein, the glass transition point is a temperature of an inflection point of a DSC curve which is obtained by measuring 5 to 10 mg of a sample at a temperature rise rate of 5° C./min using differential scanning calorimeter (specifically, DSC6220 (trade name) manufactured by 511 NanoTechnology Inc.).

In the present invention, a number average molecular weight of the polyester polyol (B) is preferably from 2,000 to 10,000, more preferably from 2,000 to 8,000, and most preferably from 2,500 to 7,000. When the polyester polyol (B) has the number average molecular weight within the above range, the hot melt adhesive according to the present invention is excellent in adhesion to a paper and is also excellent in low temperature coating.

As used herein, the number average molecular weight is measured by gel permeation chromatography (GPC). Details of the measurement of the number average molecular weight of the polyester polyol (B) are the same as those in the case of the measurement of the above-mentioned weight average molecular weight of the olefin copolymer (A).

The polyester polyol (B) can be obtained, for example, by a condensation polymerization reaction of a low molecular weight polyol with dicarboxylic acid or an anhydride thereof.

The low molecular weight polyol is preferably a polyol having 1 to 3 functional groups, and particularly preferably a difunctional polyol, that is, so-called diol. These polyols can be used alone or in combination.

Examples of the diol include low molecular weight diols such as ethylene glycol, 1-methylethylene glycol, 1-ethyl ethylene glycol, propylene glycol, butanediol, pentanediol, hexanediol, heptanediol, octanediol, nonanediol, decanediol, neopentyl glycol, 2-methyl-1,3-propanediol, cyclohexanedimethanol, 2,4-dimethyl-1,5-pentanediol, and 2,4-dibutyl-1,5-pentanediol.

In the present invention, the diol preferably contains, as a raw material of the polyester polyol (B), at least one selected from ethylene glycol, neopentyl glycol, and hexanediol.

Examples of the dicarboxylic acid include oxalic acid, malonic acid, succinic acid, glutaric acid, adipic acid, pimelic acid, suberic acid, azelaic acid, sebacic acid, dodecanedioic acid, 2-methylsuccinic acid, 2-methyladipic acid, 3-methyladipic acid, 3-methylpentanedioic acid, 2-methyloctanedioic acid, 3,8-dimethyldecanedioic acid, 3,7-dimethyldecanedioic acid, phthalic acid, terephthalic acid, isophthalic acid, naphthalenedicarboxylic acid, trimellitic acid, trimesic acid, cyclohexanedioic acid and the like. These dicarboxylic acids are used alone or in combination.

Examples of the carboxylic anhydride include acetic anhydride, propionic anhydride, succinic anhydride, maleic anhydride, and phthalic anhydride. These carboxylic anhydrides can be used alone or in combination.

In the present invention, these dicarboxylic acids and anhydrides thereof preferably contain, as the raw material of the polyester polyol (B), at least one selected from phthalic acids such as phthalic acid, terephthalic acid, isophthalic acid, and phthalic anhydride; and adipic acids such as adipic acid, 2-methyladipic acid and 3-methyladipic acid.

Therefore, the polyester polyol (B) according to the present invention is preferably at least one selected from chemical structures derived from phthalic acids and chemical structures derived from adipic acids. When the polyester polyol (B) has the above chemical structure, the hot melt adhesive according to the present invention is more excellent in adhesion to a carton even though a small amount of the adhesive is applied, and the adhesive can exhibit more excellent adhesion in a low temperature range of −20° C. to 0° C.

The chemical structure derived from phthalic acids preferably contains —CO—C₆H₄—CO— (which may be any of substitution patterns o-, m-, and p-), and the chemical structure derived from adipic acids preferably contains —CO—C₄H₈—CO—, —CO—CH(CH₃)—C₃H₆—CO—, and —CO—CH₂—CH(CH₃)—C₂H₄—CO—.

In the present invention, it is preferable that the hot melt adhesive further contains (C) a wax. As used herein, the “wax” means an organic substance having a weight average molecular weight of less than 10,000 which is solid at normal temperature and becomes liquid when heated, and is commonly regarded as a “wax”, and there is no particular limitation as long as it has waxy properties and the hot melt adhesive according to the present invention can be obtained.

The wax (C) preferably includes both (C1) a Fischer-Tropsch wax which is one of synthetic waxes, and (C2) a petroleum wax which is one of natural waxes.

The Fischer-Tropsch wax (C1) means a wax which is synthesized by the Fischer-Tropsch method and is commonly regarded as a Fischer-Tropsch wax. The Fischer-Tropsch wax is obtained by separating a wax from a wax in which component molecules have comparatively wide carbon number distribution such that component molecules have comparatively narrow carbon number distribution. Typical Fischer-Tropsch waxes include Sasol H1 (trade name) and Sasol C80 (trade name), both of which being commercially available from Sasol Wax Corporation.

Examples of the petroleum wax (C2) include paraffin wax, microcrystalline wax, and petrolatum.

The paraffin wax is a wax which is solid at normal temperature, produced by separating from vacuum distillation extract oil. Typical paraffin wax includes Paraffin Wax Series manufactured by NIPPON SEIRO CO., LTD.

The microcrystalline wax is a wax which is solid at normal temperature, produced by separating from a vacuum distillation bottom or heavy extract oil. Typical microcrystalline wax includes Hi-Mic Series manufactured by NIPPON SEIRO CO., LTD.

The petrolatum is a wax which is semi-solid at normal temperature, produced by separating from a vacuum distillation bottom. Typical petrolatum includes Centon CP Series manufactured by CHUO YUKA CO., LTD. In the present invention, the petroleum wax (C2) is preferably paraffin wax or microcrystalline wax.

In the present invention, the wax (C) may contain, in addition to the Fischer-Tropsch wax (C1) or the petroleum wax (C2), synthetic waxes such as polyolefin wax (for example, polyethylene wax, polypropylene wax, polyethylene/polypropylene wax); and natural waxes such as caster wax.

In addition to the components (A), (B), and (C), the hot melt adhesive according to the present invention may preferably contain (D) a tackifier. When the hot melt adhesive according to the present invention contains (D) a tackifier resin, low temperature coatability and adhesion to a paper are more improved while maintaining thermal stability.

There is no particular limitation on the “tackifier resin” as long as it is commonly used in the hot melt adhesive, and the objective hot melt adhesive according to the present invention can be obtained.

Examples of the tackifier resin include, a natural rosin, a modified rosin, a hydrogenated rosin, a glycerol ester of a natural rosin, a glycerol ester of a modified rosin, a pentaerythritol ester of a natural rosin, a pentaerythritol ester of a modified rosin, a pentaerythritol ester of a hydrogenated rosin, a copolymer of a natural terpene, a terpolymer of a natural terpene, a hydrogenated derivative of a copolymer of a hydrogenated terpene, a polyterpene resin, a hydrogenated derivative of a phenol-based modified terpene resin, an aliphatic petroleum hydrocarbon resin, a hydrogenated derivative of an aliphatic petroleum hydrocarbon resin, an aromatic petroleum hydrocarbon resin, a hydrogenated derivative of an aromatic petroleum hydrocarbon resin, a cyclic aliphatic petroleum hydrocarbon resin, and a hydrogenated derivative of a cyclic aliphatic petroleum hydrocarbon resin. These tackifier resins can be used alone or in combination. A liquid type tackifier resin can be used as long as the tackifier resin has a colorless to pale yellow color tone and is substantially free from odor, and also has satisfactory thermal stability. Taking these characteristics into consideration comprehensively, hydrogenated derivatives of the above-mentioned resins are preferable as the tackifier resin.

Commercially available products can be used as the tackifier resin. Examples of the commercially available products include ECR5600 (trade name) manufactured by Exxon Mobil Corporation; MARUKACLEAR H (trade name) manufactured by Maruzen Petrochemical CO, LTD.; CLEARON K100 (trade name) manufactured by YASUHARA CHEMICAL CO., LTD.; Alkon M100 (trade name) manufactured by Arakawa Chemical Industries, Ltd.; I-MARV S100 (trade name) and I-MARV Y135 (trade name) manufactured by Idemitsu Petroleum Chemical Co., Ltd.; CLEARON K4090 (trade name) and CLEARON K4100 manufactured by YASUHARA CHEMICAL CO., LTD.; ECR231C (trade name) and ECR179EX (trade name) manufactured by Exxon Mobil Corporation; and Rigarite R7100 (trade name) manufactured by Eastman Chemical Company. These commercially available tackifier resins can be used alone or in combination.

The hot melt adhesive according to the present invention preferably contains a tackifier resin (D) in the amount of 40 to 100 parts by weight, and most preferably 50 to 80 parts by weight, based on 100 parts by weight of the total weight of the components (A) to (C).

When the hot melt adhesive according to the present invention contains the components (A) to (D) in the above proportions, the hot melt adhesive is more suited to low temperature coating and is more excellent in thermal stability, and also has suitably long open time and is more excellent in adhesion to a paper, and thus being more suited for applications of assembling a small carton to which a large amount of a hot melt adhesive cannot be easily applied.

The hot melt adhesive according to the present invention may further contain various additives, if necessary. Examples of the various additives include plasticizers, ultraviolet absorbers, antioxidants, stabilizers, and fine particle fillers.

There is no particular limitation on the “plasticizer”, as long as the plasticizer is mixed for the purpose of decreasing a melt viscosity of a hot melt adhesive, imparting flexibility and improving wetting to an adherend and is compatible with an ethylene-based copolymer, and also the objective hot melt adhesive according to the present invention can be obtained. Examples of the plasticizer include paraffin-based oil, naphthene-based oil and aromatic oil. Colorless and odorless paraffin-based oil is particularly preferable.

Commercially available products can be used as the plasticizer. Examples thereof include White Oil Broom 350 (trade name) manufactured by Kukdong Oil & Chemical Co., Ltd.; Diana Frecia S32 (trade name), Diana Process Oil PW-90 (trade name) and DN Oil KP-68 (trade name) manufactured by idemitsu Kosan Co., Ltd.; Enerper M1930 (trade name) manufactured by BP Chemicals Ltd.; Kaydol (trade name) manufactured by Crompton Corporation; and Primol 352 (trade name) manufactured by Esso Corporation. These plasticizers can be used alone or in combination.

The “stabilizer” is mixed so as to improve stability of the hot melt adhesive by preventing decrease in molecular weight due to heat, as well as occurrence of gelation, coloration and odor of the hot melt adhesive. There is no particular limitation on the stabilizer, as long as the objective hot melt adhesive according to the present invention can be obtained. Examples of the stabilizer include an antioxidant and an ultraviolet absorber.

The “ultraviolet absorber” is used so as to improve light resistance of the hot melt adhesive. The “antioxidant” is used so as to depress oxidative degradation of the hot melt adhesive. There is no particular limitation on the antioxidant and ultraviolet absorber, as long as the antioxidant and ultraviolet absorber are generally used in hot melt adhesives, and below-mentioned objective paper products can be obtained.

Examples of the “antioxidant” include a phenol-based antioxidant, a sulfur-based antioxidant and a phosphorus-based antioxidant. Examples of the ultraviolet absorber include a benzotriazole-based ultraviolet absorber and a benzophenone-based ultraviolet absorber. A lactone-based stabilizer can also be added. These antioxidants and ultraviolet absorbers can be used alone or in combination.

It is possible to use, as the stabilizer, commercially available products. Examples thereof include SUMILIZER GM (trade name), SUMILIZER TPD (trade name) and SUMILIZER TPS (trade name) manufactured by Sumitomo Chemical Company; Limited, IRGANOX 1010 (trade name), IRGANOX HP2225FF (trade name), IRGAFOS 168 (trade name) and IRGANOX 1520 (trade name) manufactured by Ciba Specialty Chemicals Co., Ltd.; and JF77 (trade name) manufactured by Johoku Chemical Co., Ltd. These stabilizers can be used alone or in combination.

The hot melt adhesive according to the present invention can further contain a fine particle filler. There is no particular limitation on the fine particle filler, as long as the fine particle filler is generally used and the objective hot melt adhesive according to the present invention can be obtained. Examples of the “fine particle filler” include mica, calcium carbonate, kaolin, talc, titanium oxide, diatomaceous earth, urea-based resin, styrene beads, baked clay, starch and the like. The shape of these fine particle fillers is preferably spherical. There is no particular limitation on the size (diameter in case of a spherical).

Melt viscosity at 130° C. of the hot melt adhesive according to the present invention is preferably from 400 to 2,000 mPa·s. When the melt viscosity at 130° C. is within the above range, applicability at 130° C. of the hot melt adhesive is improved, and also adhesion to a paper or thermal stability is maintained. As used herein, the melt viscosity at 130° C. means a value measured by a rotor No. 27 using a Brookfield viscometer and a thermo-cell.

The hot melt adhesive according to the present invention can be produced by mixing a copolymer of ethylene/olefin (A) and a polyester polyol (B) and, optionally, a wax (C), a tackifier resin (D) and various additives using a generally known method for producing a hot melt adhesive. For example, it can be produced by mixing the above-mentioned components in a predetermined amount, and heating and melting the mixture. There is no particular limitation on the order of adding each component, heating method and the like, as long as the objective hot melt adhesive can be obtained.

The hot melt adhesive according to the present invention can take various forms and is commonly in the form of a block or a film (sheet). The hot melt adhesive in the form of a block can be obtained by solidifying the product obtained by the above production method with cooling, while the hot melt adhesive in the form of a film (sheet) can be obtained by further forming the product obtained by the above production method into a film.

The hot melt adhesive according to the present invention can be used by being applied to a target such as a base material or an adherend. It is not necessary to mix an organic solvent in the hot melt adhesive in coating, and therefore the hot melt adhesive is environmentally preferable.

There is no particular limitation on the coating method, and generally known methods of applying (coating) of a hot melt adhesive can be used. The coating methods are, for example, roughly classified into contact coating and non-contact coating. The “contact coating” means a coating method in which a dispenser is brought into contact with a member or a film in application of a hot melt adhesive, whereas, the “non-contact coating” means a coating method in which a dispenser is not brought into contact with a member or a film in application of a hot melt adhesive. Examples of the contact coating method include a slot coater coating and a roll coater coating. Examples of the non-contact coating method include a spiral coating method capable of spiral coating; omega coating and control seam coating methods capable of wavy coating; slot spray coating and curtain spray coating methods capable of planar coating; a dot coating method capable of spot-like coating; a bead coating method capable of linear coating; and the like.

The hot melt adhesive according to the present invention is applied to a base material at low temperature of about 130° C. by the above-mentioned coating method.

The hot melt adhesive according to the present invention is widely used, for example, in electronic components, woodworking, building materials, sanitary materials, paper product and the like, and can be suitably used so as to produce a paper product and it is particularly useful as a hot melt adhesive for paper products.

The paper product according to the present invention means a paper product produced by using the above-mentioned hot melt adhesive. There is no particular limitation on the kind of the paper product, as long as the paper product is produced by using the above-mentioned hot melt adhesive. Specific examples thereof include bookbinding, calendar, corrugated cardboard, carton and the like.

One preferred embodiment of the paper product according to the present invention includes a portable wrapping carton such as a portable sweets box (for example, chocolate box).

Main embodiments of the present invention are shown below.

1. A hot melt adhesive comprising: (A) a copolymer of ethylene/olefin having 3-20 carbons; and (B) a polyester polyol.
2. The hot melt adhesive according to the above 1, wherein the copolymer of ethylene/olefin having 3-20 carbons (A) includes a copolymer of ethylene with octene.
3. The hot melt adhesive according to the above 1 or 2, wherein the polyester polyol (B) has a glass transition temperature of 30° C. or lower.
4. The hot melt adhesive according to any one of the above 1 to 3, wherein the polyester polyol (B) has at least one chemical structure selected from chemical structures derived from phthalic acids and chemical structures derived from adipic acids.
5. A paper product produced by using the hot melt adhesive according to any one of the above 1 to 4.

### EXAMPLES

The present invention will be described below by way of Examples and Comparative Examples, but the present invention is not limited to these Examples.

Components of hot melt adhesives are shown below.

(A) Copolymer of Ethylene/Olefin Having 3-20 Carbons

(A1) Copolymer of ethylene/octene (weight average molecular weight: 43,000, 1-octene content: 35 to 37% by weight, melt flow rate: 500, manufactured by The Dow Chemical Company under the trade name of AFFINITY GA1950)

(A2) Copolymer of ethylene/octene (weight average molecular weight: 38,000, 1-octene content: 35 to 37% by weight, melt flow rate: 1,000, manufactured by The Dow Chemical Company under the trade name of AFFINITY GA1900)

(A3) Copolymer of propylene/ethylene/1-butene (weight average molecular weight: 34,000, glass transition point: −28° C., softening point: 124° C., melt viscosity at 190° C.: 2,700 mPa·s, manufactured by EVONIK DEGUSSA under the trade name of VESTPLAST703)

(A4) Copolymer of ethylene/propylene (weight average molecular weight: 38,000, glass transition point: −25° C., softening point: 135° C., melt viscosity at 190° C.: 1,600 mPa·s, manufactured by Eastman Chemical Company under the trade name of Eastflex E1016PL-1)

(A′) Copolymer of Ethylene/Carboxylic Acid Ester

(A′1) Copolymer of ethylene/vinyl acetate (weight average molecular weight: 59,000, vinyl acetate content: 28% by weight, melt flow rate: 400, manufactured by TOSOH CORPORATION under the trade name of ULTRASEN 722)

(A′2) Copolymer of ethylene/methyl methacrylate (weight average molecular weight: 71,000, methyl methacrylate content: 32% by weight, melt flow rate: 450, manufactured by Sumitomo Chemical Co., Ltd. under the trade name of Acrift CM5022)

(A′3) Copolymer of ethylene/methyl acrylate (weight average molecular weight: 68,000, methyl acrylate content: 28% by weight, melt flow rate: 250, manufactured by The Dow Chemical Company under the trade name of NUC-6070)

(B) Polyester Polyol

(B1) Copolymer of terephthalic acid, phthalic anhydride and adipic acid with ethylene glycol (number average molecular weight: 3,500, glass transition point: −31° C., manufactured by HOKOKU Co., Ltd. under the trade name of HS Polyol 2000)

(B2) Copolymer of adipic acid, isophthalic acid and terephthalic acid with neopentyl glycol and ethylene glycol (number average molecular weight: 3,000, glass transition point: 20° C., manufactured by HOKOKU Co., Ltd. under the trade name of HS Polyol 1000)

(B3) Copolymer of adipic acid with neopentyl glycol, ethylene glycol and hexanediol (number average molecular weight: 5,500, glass transition point: −50° C., manufactured by HOKOKU Co., Ltd. under the trade name of HS 2E-581A) (B4) Copolymer of adipic acid with hexanediol (number average molecular weight: 3,500, glass transition point: −57° C., manufactured by HOKOKU Co., Ltd. under the trade name of HS 2H-351A)

(C) Wax

(C1) Fischer-Tropsch wax (weight average molecular weight: 800, melting point: 80° C., penetration degree: 7 or less, manufactured by Sasol Corp. under the trade name of Sasol C80)

(C2-1) Petroleum wax, paraffin wax (weight average molecular weight: 460, melting point: 66° C., penetration degree: 12, manufactured by NIPPON SEIRO CO., LTD under the trade name of Paraffin Wax-150)

(C2-2) Petroleum wax, microcrystalline wax (weight average molecular weight: 800, melting point: 88° C., penetration degree: 6, manufactured by NIPPON SEIRO CO., LTD under the trade name of Hi-MiC-1090)

(D) Tackifier Resin

(D1) Thermoplastic hydrocarbon resin (softening point: 100° C., manufactured by Exxon Mobil Corporation under the trade name of ECR-179EX)

(D2) Aliphatic hydrocarbon resin (softening point: 90° C., manufactured by Zeon Corporation under the trade name of Quinton DX390N)

According to formulations shown in Tables 1 to 3, these components were melted and mixed at about 145° C. over about 1 hour using a universal stirrer to prepare hot melt adhesives of Examples 1 to 9, and Comparative Examples 1 to 4.

With respect to the above hot melt adhesives, melt viscosity, low temperature coatability, open time, and adhesion were evaluated.

The hot melt adhesive was applied to a K liner (or Kraft liner) corrugated cardboard to obtain samples for evaluating the low temperature coatability and the open time. Summaries of each evaluation are described below.

<Melt Viscosity>

### (Test Method)

Using a Brookfield viscometer and a thermo-cell, melt viscosity at 130° C. was measured.

<Low Temperature Coatability>

### (Test Method)

A hot melt adhesive melted at 130° C. was applied to a K liner (or Kraft liner) corrugated cardboard in a coating amount of 2 g/m, and then the K liner corrugated cardboard was laminated to the other K liner corrugated cardboard under the conditions of a setting time of 10 seconds and a pressing pressure of 1 kg/25 cm². After forcibly peeling, a spreading state of the hot melt adhesive was measured.

A: Spread of hot melt adhesive was more than 10 mm.

B: Spread of hot melt adhesive was from 8 to 10 mm.

C: Spread of hot melt adhesive was less than 18 mm.

<Open Time>

### (Evaluation Method)

A hot melt adhesive melted at 130° C. was applied to a K liner corrugated cardboard in a coating amount of 2 g/m, and then the K liner corrugated cardboard was laminated to the other K liner corrugated cardboard under the conditions of a setting time of 10 seconds and a pressing pressure of 1 kg/25 cm². A time in which bonding can be performed was measured.

A: Open time was longer than 12 seconds.

B: Open time was from 10 to 12 seconds.

C: Open time was shorter than 10 seconds.

<Adhesion>

### (Preparation of Samples)

A hot melt adhesive was melted at 130° C. and applied to a carton having a surface coated with a chemical. A coating amount was 1.2 g/m.

A sample was prepared by laminating the other carton under the conditions of a set time of 1 second and an open time of 5 seconds under a pressurizing pressure of 1 kg/25 cm².

### (Evaluation Method)

Each prepared sample was aged in a constant temperature bath set to 40° C., 23° C., 0° C., −10° C., or −20° C. for 24 hours, and then two cartons were forcibly peeled by hands under the atmosphere. The proportion of fractured portion(s) (material fracture ratio) was examined by visually observing the state of the peeled surface. The proportion of the area of the fractured carton in the total bonding area is regarded as a proportion of a fractured portion(s) of material (material fracture ratio).

A: A material fracture ratio was more than 80%.

B: A material fracture ratio was from 65% to 80%.

C: A material fracture ratio was less than 65%.

TABLE 1

| | | Example 1 | Example 2 | Example 3 | Example 4 | Example 5 |
|---|---|---|---|---|---|---|
| (A) | (A1) | 52 | | | | |
| | (A2) | | 52 | 54 | 55 | |
| | (A3) | | | | | 52 |
| | (A4) | | | | | |
| (A′) | (A′1) | | | | | |
| | (A′2) | | | | | |
| | (A′3) | | | | | |
| (B) | (B1) | 6 | 6 | 8 | 7 | |
| | (B2) | | | | | |
| | (B3) | | | | | |
| | (B4) | | | | | |
| (C) | (C1) | 21 | 21 | 19 | 19 | 21 |
| | (C2-1) | 21 | 21 | 19 | 19 | 21 |
| | (C2-2) | | | | | |
| Total of (A) to (C) | | 100 | 100 | 100 | 100 | 100 |
| (D) | (D1) | 42 | 42 | 33 | 28 | 42 |
| | (D2) | 31 | 31 | 29 | 28 | 31 |

| | | | | | |
|---|---|---|---|---|---|
| Total amount of (A) to (D) | 173 | 173 | 162 | 156 | 173 |
| Melt viscosity (mPa · s) | | | | | |
| 120° C. | 1,750 | 1,370 | 1,900 | 2,030 | 970 |
| 130° C. | 1260 | 980 | 1340 | 1480 | 520 |
| 140° C. | 930 | 720 | 940 | 1030 | 370 |
| Low temperature coatability | A | A | A | A | A |
| Open time | A | A | A | A | A |
| Adhesion | | | | | |
| 40° C. | A | A | A | A | B |
| 23° C. | A | A | A | A | A |
| 0° C. | A | A | A | A | B |
| −10° C. | A | A | A | A | B |
| −20° C. | A | A | A | B | B |

TABLE 2

| | | Example | Example | Example | Example |
|---|---|---|---|---|---|
| | | 6 | 7 | 8 | 9 |
| (A) | (A1) | | 52 | 52 | 52 |
| | (A2) | | | | |
| | (A3) | | | | |
| | (A4) | 52 | | | |
| (A′) | (A′1) | | | | |
| | (A′2) | | | | |
| | (A′3) | | | | |
| (B) | (B1) | 6 | | | |
| | (B2) | | 6 | | |
| | (B3) | | | 6 | |
| | (B4) | | | | 8 |
| (C) | (C1) | 21 | 21 | 21 | 21 |
| | (C2-1) | 21 | 21 | 21 | 21 |
| | (C2-2) | | | | |
| Total of (A) to (C) | | 100 | 100 | 100 | 100 |
| (D) | (D1) | 42 | 42 | 42 | 42 |
| | (D2) | 31 | 31 | 31 | 31 |

| | | | | |
|---|---|---|---|---|
| Total amount of (A) to (D) | 173 | 173 | 173 | 173 |
| Melt viscosity (mPa · s) | | | | |
| 120° C. | 1,750 | 1,830 | 1,700 | 1,790 |
| 130° C. | 1,260 | 1,320 | 1,300 | 1,350 |
| 140° C. | 930 | 930 | 900 | 900 |
| Low temperature coatability | A | A | A | A |
| Open time | A | A | A | B |
| Adhesion | | | | |
| 40° C. | A | A | A | A |
| 23° C. | A | A | A | B |
| 0° C. | A | A | A | B |
| −10° C. | A | B | B | B |
| −20° C. | A | B | B | B |

TABLE 3

| | | Comparative | Comparative | Comparative | Comparative |
|---|---|---|---|---|---|
| | | Example 1 | Example 2 | Example 3 | Example 4 |
| (A) | (A1) | | | | 58 |
| | (A2) | | | | |
| | (A3) | | | | |
| | (A4) | | | | |
| (A′) | (A′1) | 52 | | | |
| | (A′2) | | 52 | | |
| | (A′3) | | | 52 | |
| (B) | (B1) | 6 | 6 | 6 | |
| | (B2) | | | | |
| | (B3) | | | | |
| | (B4) | | | | |
| (C) | (C1) | 21 | 21 | 21 | 21 |
| | (C2-2) | 21 | 21 | 21 | 21 |
| | (C2-2) | | | | |
| Total of | | 100 | 100 | 100 | 100 |
| (A) to (C) | | | | | |
| (D) | (D1) | 42 | 42 | 42 | 42 |
| | (D2) | 31 | 31 | 31 | 31 |

| | | | | |
|---|---|---|---|---|
| Total amount | 173 | 173 | 173 | 173 |
| of (A) to (D) | | | | |
| Melt viscosity | | | | |
| (mPa · s) | | | | |
| 120° C. | 2,590 | 2,360 | 2,630 | 1,790 |
| 130° C. | 1,820 | 1,650 | 1,870 | 1,350 |
| 140° C. | 1,310 | 1,180 | 1,410 | 900 |
| Low | B | A | B | B |
| temperature | | | | |
| coatability | | | | |
| Open time | A | A | B | B |
| Adhesion | | | | |
| 40° C. | B | B | B | B |
| 23° C. | B | A | A | B |
| 0° C. | B | A | A | C |
| −10° C. | C | B | C | C |
| −20° C. | C | C | C | C |

As shown in Tables 1 to 3, the hot melt adhesives of Examples 1 to 9 included both the component (A) and the component (B), and therefore enabled low temperature coating, and also had a suitably long open time and were excellent in adhesion to a paper.

To the contrary, the hot melt adhesives of Comparative Examples 1 to 4 were inferior in adhesion to the carton in a low temperature range as compared with the hot melt adhesives of Examples. It was proved that ensuring of sufficient adhesion to the carton was difficult when the amount of the hot melt adhesives of Comparative Examples coated to the carton was 1.2 g/m.

Therefore, the hot melt adhesive according to the present invention is suited for a portable sweets box (for example, chocolate box) as compared with the hot melt adhesive of Comparative Example.

### INDUSTRIAL APPLICABILITY

The present invention provides a hot melt adhesive. The hot melt adhesive according to the present invention is suited in paper processing field, particularly production of bookbinding, calendar, corrugated cardboard, portable sweets box and the like.

1. A hot melt adhesive comprising:
(A) a copolymer of ethylene/olefin having 3-20 carbons; and
(B) a polyester polyol.

2. The hot melt adhesive according to claim 1, wherein the copolymer of ethylene/olefin having 3-20 carbons (A) includes a copolymer of ethylene with octene.

3. The hot melt adhesive according to claim 1, wherein the polyester polyol (B) has a glass transition temperature of 30° C. or lower.

4. The hot melt adhesive according to claim 1, wherein the polyester polyol (B) has at least one chemical structure selected from chemical structures derived from phthalic acids and chemical structures derived from adipic acid.

5. The hot melt adhesive according to claim 4, wherein the least one chemical structure selected from chemical structures derived from phthalic acids is selected from the group consisting of phthalic acid, terephthalic acid, isophthalic acid, and phthalic anhydride; and adipic acids such as adipic acid, 2-methyladipic acid, 3-methyladipic acid, and mixtures thereof.

6. A hot melt adhesive comprising:
(A) an ethylene with octene; and
(B) a polyester polyol that has a glass transition temperature of 30° C. or lower, and is reaction product of polyol and a phthalic acid derivative;
wherein the polyol is selected from ethylene glycol, neopentyl glycol or hexanediol; and
wherein the phthalic acids derivative is selected from the group consisting of phthalic acid, terephthalic acid, isophthalic acid, and phthalic anhydride; and adipic acids such as adipic acid, 2-methyladipic acid, 3-methyladipic acid, and mixtures thereof

7. An article comprising the adhesive of claim 4, which is a paper product.

8. An article comprising the adhesive of claim 6, which is a paper product.
